(19) United States
(12) Patent Application Publication
(10) Pub. No.: US 2022/0319546 A1
(43) Pub. Date: Oct. 6, 2022

(54) MAGNETIC RECORDING MEDIUM, MAGNETIC STORAGE APPARATUS, AND METHOD FOR MANUFACTURING MAGNETIC RECORDING MEDIUM

(71) Applicants: SHOWA DENKO K.K., Tokyo (JP); TOHOKU UNIVERSITY, Miyagi (JP)

(72) Inventors: Chen XU, Chiba (JP); Gohei KUROKAWA, Chiba (JP); Lei ZHANG, Chiba (JP); Takayuki FUKUSHIMA, Chiba (JP); Tomoo SHIGE, Chiba (JP); Shin SAITO, Miyagi (JP)

(21) Appl. No.: 17/656,964

(22) Filed: Mar. 29, 2022

(30) Foreign Application Priority Data
Apr. 5, 2021 (JP) 2021-064071

(51) Int. Cl. G11B 5/66; G11B 5/851

(52) U.S. Cl. CPC G11B 5/66; G11B 5/851

(57) ABSTRACT

A magnetic recording medium includes a magnesium oxide underlayer including magnesium oxide, and a magnetic layer including an alloy having a L1₀ structure and includes Fe or Co and Pt. The magnesium oxide has a peak of an O1s spectrum detected in a range of 531 eV to 533 eV when measured by X-ray photoelectron spectroscopy.

### CROSS-REFERENCE TO RELATED APPLICATIONS

This application is based upon and claims priority to Japanese Patent Application No. 2021-064071 filed on Apr. 5, 2021, the entire contents of which are incorporated herein by reference.

### BACKGROUND OF THE INVENTION

### 1. Field of the Invention

The present disclosure relates to magnetic recording media, magnetic storage apparatuses, and methods for manufacturing magnetic recording media.

### 2. Description of the Related Art

A magnetic recording medium is generally manufactured by successively laminating an underlayer, a magnetic layer, and protective layer on a substrate. As a method for magnetically recording information on the magnetic recording medium, there is the thermal assist recording method which magnetically records the information by irradiating laser light or the like onto the magnetic recording medium to locally heat the surface of the magnetic layer, to thereby reduce a coercivity of the magnetic layer. Because the thermal assist recording method can realize a surface recording density on the order of 1 Tbit/inch², the thermal assist recording method is regarded as a next-generation magnetic recording method which can increase a storage capacity, and at the same time reduce the size of the magnetic recording medium and increase the recording density of the magnetic recording medium.

An example of the magnetic recording medium, which can be used for the thermal assist recording method, includes a substrate, a plurality of underlayers formed on the substrate, and a magnetic layer including an alloy having an L1₀ structure as a main component thereof. Such a magnetic recording medium is proposed in Japanese Laid-Open Patent Publication No. 2016-026368, for example, wherein the plurality of underlayers includes a NiO underlayer and an orientation control layer. In this proposed magnetic recording medium, the orientation control layer includes an underlayer including an alloy having a BCC structure, and an underlayer including MgO or the like and having a NaCl structure, so as to promote a (100) orientation of the NiO underlayer.

When a FePt alloy having the L1₀ structure is used as the magnetic layer of the magnetic recording medium, a (001) plane is used as a crystal orientation plane of the magnetic layer. Generally, (100) oriented MgO is used for the underlayer, in order to achieve the (001) orientation of the FePt alloy. In other words, because the (100) plane of MgO is lattice-matched to the (001) plane of the FePt alloy to a high extent, the (001) orientation of the FePt alloy is facilitated by depositing a magnetic layer including the FePt alloy above the MgO layer. Moreover, in the magnetic recording medium proposed in Japanese Laid-Open Patent Publication No. 2016-026368, because the NiO underlayer also has the (100) orientation, MgO is used as the underlayer layer of the orientation control layer.

When MgO is used to form the orientation control layer, a sputtering method is generally employed to form the MgO layer, but sinterability (or degree of sintering) of MgO is poor because MgO has a high melting point. When the MgO layer is formed by the sputtering method using a target having a poor sinterability, abnormal discharge (arcing) occurs at the target surface, thereby causing melting and scattering of the target surface, and introduce a problem in that sputtering dust is easily generated. This sputtering dust deteriorates the crystal orientation of the MgO layer, and generates defects in the MgO layer. For this reason, the crystal orientation of the magnetic layer formed on the MgO layer deteriorates, thereby increasing the possibility of generating defects in the magnetic layer.

### SUMMARY OF THE INVENTION

One object according to one aspect of embodiments of the present disclosure is to provide a magnetic recording medium which can have a magnetic layer with a high crystal orientation and reduced defects, a magnetic storage apparatus including such a magnetic recording medium, and a method for manufacturing such a magnetic recording medium.

One aspect of the embodiments of the present disclosure provides a magnetic recording medium which includes a magnesium oxide underlayer including magnesium oxide, and a magnetic layer including an alloy having a L1₀ structure and includes Fe or Co and Pt, wherein the magnesium oxide has a peak in an O1s spectrum detected in a range of 531 eV to 533 eV when measured by an X-ray photoelectron spectroscopy.

Another aspect of the embodiments of the present disclosure provides a method for manufacturing a magnetic recording medium, which includes forming a magnesium oxide underlayer on a surface of a substrate by a sputtering method using a target which includes magnesium oxide, and forming a magnetic layer on a surface of the magnesium oxide underlayer, wherein the target including the magnesium oxide is heated to a temperature of 600° C. or higher when forming the magnesium oxide underlayer.

Other objects and further features of the present disclosure will be apparent from the following detailed description when read in conjunction with the accompanying drawings.

### BRIEF DESCRIPTION OF THE DRAWINGS

FIG. 1 is a cross sectional view illustrating an example of a configuration of a magnetic recording medium according to an embodiment of the present disclosure;

FIG. 2 is a diagram for explaining a step of a method for manufacturing the magnetic recording medium according to one embodiment of the present disclosure;

FIG. 3 is a diagram for explaining another step of the method for manufacturing the magnetic recording medium according to one embodiment of the present disclosure;

FIG. 4 is a diagram illustrating an example of a relationship between a target temperature of a MgO target and an amount of sputtering dust generated in a chamber;

FIG. 5 is a diagram illustrating O1s spectra of magnesium oxide films measured by an XPS;

FIG. 6 is a diagram for explaining another step of the method for manufacturing the magnetic recording medium according to one embodiment of the present disclosure;

FIG. 7 is a perspective view illustrating an example of a magnetic storage apparatus using the magnetic recording medium according to one embodiment of the present disclosure; and

FIG. 8 is a schematic diagram illustrating an example of a magnetic head.

### DESCRIPTION OF THE PREFERRED EMBODIMENTS

Hereinafter, embodiments and exemplary implementations of the present disclosure will be described in detail. In order to facilitate understanding of the description, the same constituent elements in the drawings are designated by the same reference numerals, and a repeated description of the same constituent elements may be omitted. In addition, the constituent elements in the drawings may be not be drawn to actual scale, and the scale may differ among the figures. A “range from A to B” refers to a range including a lower limit value A and an upper limit value B of the range, unless otherwise indicated.

A method for manufacturing a magnetic recording medium according to the present embodiment will be described. In the description of the method for manufacturing the magnetic recording medium according to the present embodiment of the present disclosure, the magnetic recording medium manufactured by the method for manufacturing the magnetic recording medium according to the present embodiment will be described.

[Magnetic Recording Medium]

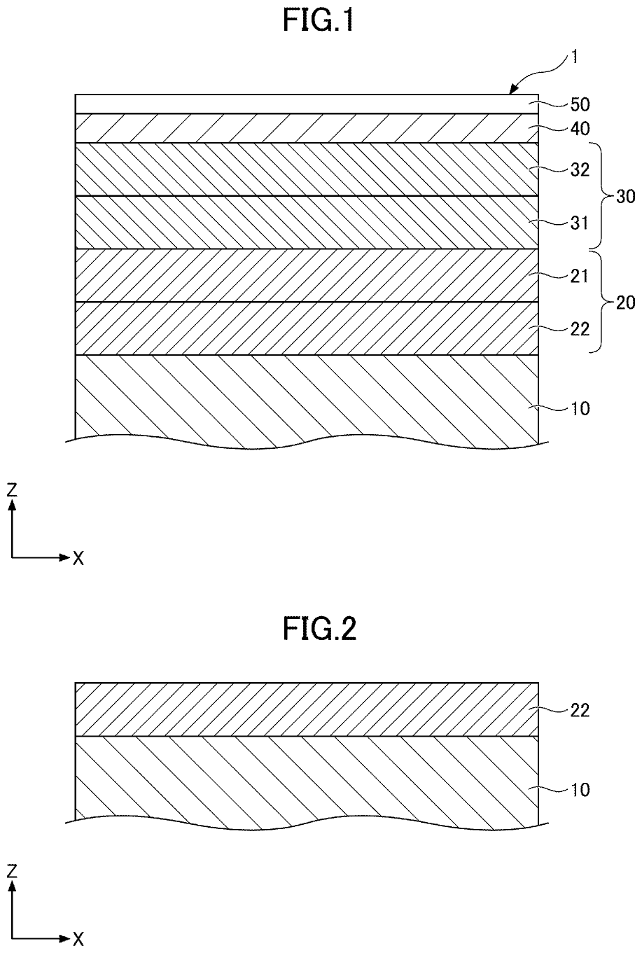

FIG. 1 is a cross sectional view illustrating an example of a configuration of the magnetic recording medium according to the present embodiment. As illustrated in FIG. 1, a magnetic recording medium 1 includes a substrate 10, an underlayer 20, and a magnetic layer 30 including an alloy having a L1₀ structure, which are successively laminated in this order.

In the present specification, a thickness direction (vertical direction) of the magnetic recording medium 1 is regarded as a Z-axis direction, and a lateral direction (horizontal direction) perpendicular to the thickness direction is regarded as an X-axis direction. The magnetic layer 30 side in the Z-axis direction is regarded as a +Z-axis direction, and the substrate 10 side is regarded as a −Z-axis direction. For the sake of convenience, the +Z-axis direction may also be referred to as up or upward direction, and the −Z-axis direction may also be referred to as down or downward direction in the following description, however, these upward and downward directions do not represent a universal vertical relationship.

In FIG. 1, the underlayer 20 and the magnetic layer 30 are illustrated only above the substrate 10. However, the magnetic recording medium 1 includes the underlayer 20 and the magnetic layer 30, which are successively laminated under the substrate 10 in this order.

The magnetic recording medium 1 includes the underlayer 20 and the magnetic layer 30 provided on both upper and lower surfaces of the substrate 10, and can record information on the magnetic layers 30 provided both upper and lower sides of the substrate 10, to achieve a two-sided recording. However, the magnetic recording medium 1 may include the underlayer 20 and the magnetic layer 30 provided on only one of the upper or lower surfaces of the substrate 10, and the information can be recorded on only one side of the substrate 10, to achieve a single-sided recording.

A material forming the substrate 10 is not particularly limited as long as the material is suitable and usable for the magnetic recording medium. Examples of the material forming the substrate 10 include Al alloys such as AlMg alloys or the like, soda glass, aluminosilicate-based glass, amorphous glass, silicon, titanium, ceramics, sapphire, quartz, resins, or the like. Among such materials, Al alloys, and glass such as crystallized glass, amorphous glass, or the like, are preferred.

The underlayer 20 includes a magnesium oxide (MgO) underlayer 21 as a first underlayer, and may include a second underlayer 22. The second underlayer 22 and the MgO underlayer (first underlayer) 21 of the underlayer 20 are successively laminated on the substrate 10 in this order.

The MgO underlayer 21 is provided above the second underlayer 22. The MgO underlayer 21 is preferably an uppermost layer of the underlayer 20, that is, the layer farthest away from the substrate 10. The MgO underlayer 21 includes MgO, and is preferably formed substantially from MgO. The MgO underlayer 21 is more preferably formed solely from MgO. Here, “formed substantially from MgO” means that, in addition to MgO, unavoidable impurities inevitably be included during a manufacturing process may also be included.

In the present embodiment, because the MgO underlayer 21 is in contact with a first magnetic layer 31, a (100) plane of the MgO is easily lattice matched to a (001) plane of a magnetic alloy having the L1₀ structure and included in the first magnetic layer 31. Hence, it is possible to improve the crystal orientation of the magnetic alloy.

As will be described later, the MgO underlayer 21 is famed by depositing a film under predetermined conditions by a sputtering method. The MgO underlayer 21 has a peak in an O1s spectrum of MgO detected in a range of 531 eV to 533 eV when measured by an X-ray photoelectron spectroscopy (XPS). Details of the manufacturing conditions and characteristics of the MgO underlayer 21 will be described later.

The second underlayer 22 is provided above the substrate 10.

A material forming the second underlayer 22 is not particularly limited, as long as it is possible to promote the (001) orientation of the first magnetic layer 31. Examples of the material forming the second underlayer 22 include W, Cr, Cr alloys having a BCC structure, alloys having a B2 structure, or the like, for example, which have the (100) orientation.

Examples of the Cr alloys having the BCC structure include CrMn alloys, CrMo alloys, CrW alloys, CrV alloys, CrTi alloys, CrRu alloys, or the like, for example.

Examples of the alloys having the B2 structure include RuAl alloys, NiAl alloys, or the like, for example.

A number of layers laminated in the underlayer 20 is not particularly limited, and may be three or more.

In a case where the number of layers laminated in the underlayer 20 is three or more, the underlayers other than the MgO underlayer 21 may be formed using a material similar to that of the second underlayer 22.

The magnetic layer 30 includes a first magnetic layer 31, and a second magnetic layer 32, which are successively laminated on the underlayer 21 in this order.

The first magnetic layer 31 is a lowermost layer of the magnetic layer 30, that is, the layer closest to the substrate 10. The first magnetic layer 31 preferably includes an alloy having the L1₀ structure.

The alloy having the L1₀ structure and forming the first magnetic layer 31 preferably further includes Fe or Co and Pt. More particularly, the alloy having the L1₀ structure is preferably a FePt alloy or a CoPt alloy. A magnetocrystalline anisotropy constant (Ku) of the FePt alloy is 7×10⁶ J/m³ or less, and the Ku of the CoPt alloy is 5×10⁶ J/m³ or less. In other words, both the FePt alloy and the CoPt alloy are materials (high-Ku materials) having a high Ku on the order of 1×10⁶ J/m³ Ku. For this reason, by using the FePt alloy or the CoPt alloy as the material forming the first magnetic layer 31, a size of magnetic grains forming the magnetic layer 30 can be reduced to a grain diameter of 6 nm or less, for example, while maintaining thermal stability.

The first magnetic layer 31 further includes a grain boundary segregation material, and may have a granular structure. In this case, it is possible to facilitate the (001) orientation of the first magnetic layer 31, and improve the lattice matching with the (100) oriented MgO underlayer 21.

Examples of the grain boundary segregation material included in the first magnetic layer 31 include nitrides such as VN, BN, SiN, TiN, or the like, carbides such as C, VC, or the like, and borides such as BN, or the like. Further, a combination of two or more kinds of these materials may be used for the grain boundary segregation material.

The second magnetic layer 32 preferably includes an alloy having the L1₀ structure, similar to the first magnetic layer 31. In this case, it is possible to improve the (001) orientation of the magnetic layer 30. In other words, the second magnetic layer 32 may be a magnetic layer grown epitaxially according to the orientation of the first magnetic layer 31.

The alloy having the L1₀ structure and forming the second magnetic layer 32 preferably includes Fe or Co and Pt, similar to the first magnetic layer 31.

The second magnetic layer 32 may further include a grain boundary segregation material, and may have a granular structure, similar to the first magnetic layer 31.

Examples of the grain boundary segregation material included in the second magnetic layer 32 include nitrides such as VN, BN, SiN, TiN, or the like, carbides such as C, VC, or the like, borides such as BN, or the like, oxides such as SiO₂, TiO₂, Cr₂O₃, Al₂O₃, Ta₂O₅, ZrO₂, Y₂O₃, CeO₂, MnO, TiO, ZnO, or the like. Further, a combination of two or more kinds of these materials may be used for the grain boundary segregation material.

A number of layers laminated in the magnetic layer 30 is not particularly limited, and may be three or more.

In a case where the number of layers laminated in the magnetic layer 30 is three or more, the magnetic layers other than the first magnetic layer 31 may be formed using a material similar to that of the second magnetic layer 32.

The magnetic recording medium 1 preferably includes a protective layer 40 provided on the magnetic layer 30.

The protective layer 40 has a function to protect the magnetic recording medium 1 from damage or the like caused by contact between the magnetic recording medium 1 and a magnetic head or the like.

A thickness of the protective layer 40 is preferably in a range of 1 nm to 6 nm. When the thickness of the protective layer 40 falls within the range of 1 nm to 6 nm, excellent floating characteristics of the magnetic head can be obtained, and a magnetic spacing can be made small, to thereby improve a signal-to-noise ratio (SNR) of the magnetic recording medium 1.

The magnetic recording medium 1 may further include a lubricant layer 50 provided on the protective layer 40.

Examples of a material forming the lubricant layer 50 include fluororesins, such as perfluoropolyether, or the like, for example.

The magnetic recording medium 1 according to the present embodiment includes the MgO underlayer 21 including MgO, and the magnetic layer 30, and the MgO included in the MgO underlayer 21 has a peak in the O1s spectrum detected in the range of 531 eV to 533 eV when measured by the XPS. Because the MgO underlayer 21 has a high crystal orientation and a small number of defects, the magnetic layer 30 formed above the MgO underlayer 21 can be famed in a manner similar to the MgO underlayer 21 to have a high crystal orientation and a small number of defects. Accordingly, the magnetic recording medium 1 can have the magnetic layer 30 having the high crystal orientation and the small number of defects, disposed above the MgO underlayer 21.

[Method for Manufacturing Magnetic Recording Medium]

A method for manufacturing the magnetic recording medium according to the present embodiment includes the steps of forming a MgO underlayer (first underlayer), and forming a magnetic layer, and may include the steps of forming a second underlayer, forming a protective layer, and forming a lubricant layer, to provide other configurations of the magnetic recording medium.

The method for manufacturing the magnetic recording medium according to the present embodiment may include the steps of forming the second underlayer, forming the MgO underlayer (first underlayer), forming the magnetic layer, forming the protective layer, and forming the lubricant layer.

In the method for manufacturing the magnetic recording medium according to the present embodiment, the second underlayer 22 may first be formed on the surface of the substrate 10, as illustrated in FIG. 2, in a second underlayer forming step.

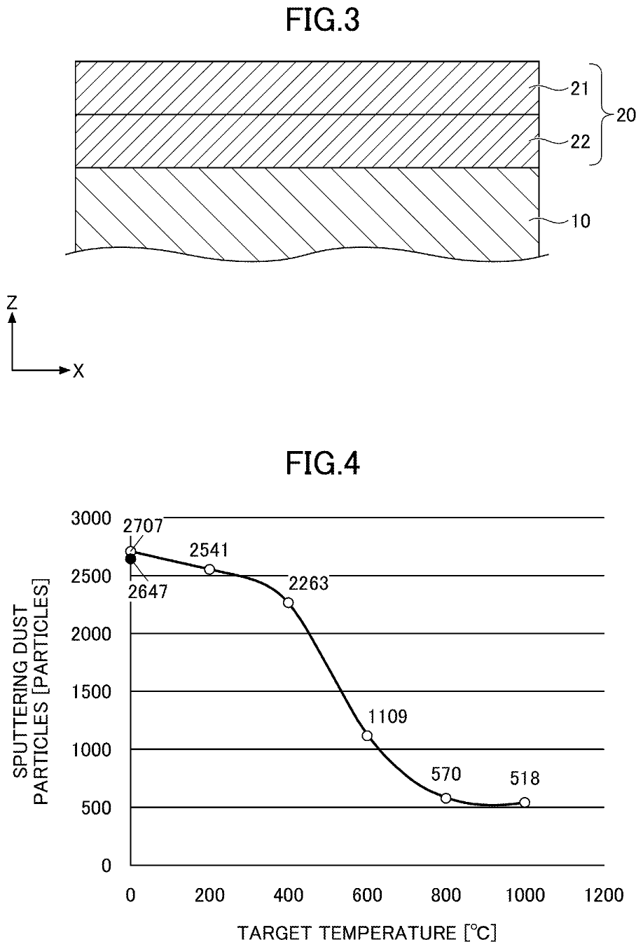

Next, an MgO underlayer 21 is formed on the surface of the second underlayer 22 by a sputtering method using a target including MgO, as illustrated in FIG. 3, in a MgO underlayer forming step.

When forming the MgO underlayer 21, the target including MgO is heated to a temperature of 600° C. or higher, and preferably to a temperature of 800° C. or higher, and more preferably to a temperature of 1000° C. or higher.

Because MgO has a high melting point, MgO has a poor sinterability. For this reason, it is difficult to manufacture a MgO target including MgO with a sufficiently high density as the sputtering target. A normal MgO target has a relative density in a range of approximately 65% to approximately 98%, and abnormal discharge (arcing) easily occurs at the target surface during the sputtering. This arcing causes melting and scattering of the target surface, thereby generating sputtering dust which adheres to a film deposition surface formed by an upper surface of the MgO underlayer 21. As a result, crystallinity of the MgO underlayer 21 deteriorates, and defects are easily generated in the MgO underlayer 21. The deteriorated crystallinity and the defects are also inherited to the magnetic layer 30 which is formed on the upper surface of the MgO underlayer 21. Consequently, the crystallinity of the magnetic layer 30 deteriorates, and the defects generated in the magnetic layer 30 generate locations on a data recording surface of the magnetic recording medium 1 where the information cannot be recorded or reproduced, and the yield of the product may deteriorate.

The present inventors diligently studied the deterioration of the crystallinity of the magnetic layer 30 and the generation of the detects in the magnetic layer 30. The present inventors studied the deposition conditions when forming the MgO underlayer 21, particularly the heating temperature of the MgO target including MgO. As a result, the present inventors found that the generation of the sputtering dust can be reduced by performing the sputtering while heating the MgO target to an extremely high temperature of 600° C. or higher, and that the MgO underlayer 21 having a high crystal orientation and reduced defects can be deposited. The present inventors also found that the crystal orientation of the magnetic layer 30 formed above the MgO underlayer 21 is also improved, and the defects in the magnetic layer 30 is also reduced.

FIG. 4 is a diagram illustrating an example of a relationship between the target temperature of the MgO target, and an amount of sputtering dust generated in a chamber of a sputtering apparatus. In FIG. 4, the ordinate indicates the number of sputtering dust particles (particles), and the abscissa indicates the target temperature (° C.). FIG. 4 illustrates a result of obtaining the amount of sputtering dust by performing the sputtering for two hours, employing a radio frequency (RF) sputtering method, using a MgO target having a relative density of 85% and a diameter of 120 mm, an input power of 1 kW, a sputtering gas pressure of 3 Pa, and As gas as the sputtering gas. The amount of sputtering dust was obtained by counting sputtering dust particles deposited on one surface of a substrate for the magnetic recording medium having a diameter of 3.5 inches, within a range in which the radius is 16 mm to 48 mm. A deposition time of the MgO film when manufacturing the magnetic recording medium is normally approximately 10 seconds. As illustrated in FIG. 4, when the sputtering is performed by setting the target temperature of the MgO target to 600° C. or higher, the number of sputtering dust particles can be reduced to ½ or less compared to when the sputtering is performed by setting the target temperature of the MgO target to 400° C. or lower.

Moreover, the MgO film manufactured by the sputtering method using the MgO target by setting the heating temperature of the MgO target to 600° C. or higher, has physical properties different from those of a MgO film manufactured by a conventional method. The conventional method refers to a method which deposits the MgO film without heating the MgO target, more particularly, the method which deposits the MgO film by setting the target temperature of the MgO target to the temperature of 400° C. or lower. In this case, a back surface of the MgO target is normally water-cooled.

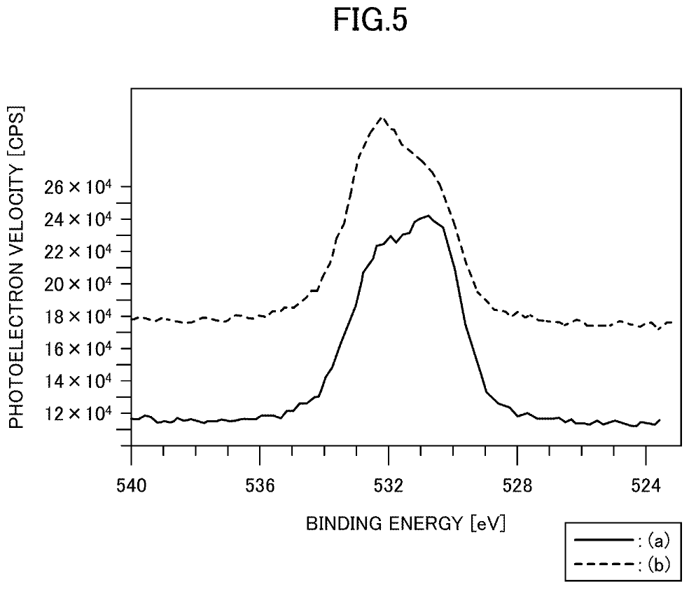

FIG. 5 is a diagram illustrating O1s spectra of magnesium oxide films measured by the XPS. In FIG. 5, the ordinate indicates the photoelectron velocity (counts per second: CPS), and the abscissa indicates the binding energy (eV). In FIG. 5, a curve (a) illustrates the spectrum of the magnesium oxide film deposited by the conventional method, and a curve (b) illustrates the spectrum of the magnesium oxide film deposited in the method for manufacturing the magnetic recording medium according to the present embodiment. As illustrated in FIG. 5, the curve (a) has a peak near 530 eV in the O1s spectrum. In contrast, the curve (b) has a peak in a range of 531 eV to 533 eV in the O1s spectrum, which is shifted by approximately 1 eV toward the high energy side.

According to the studies conducted by the present inventors, such a peak shift becomes more conspicuous toward the surface of the MgO film. It may be regarded that the peak shift occurs because a portion of the oxygen in the MgO is substituted by OH.

This substitution enhances the lattice matching between the (100) plane of MgO, and the (001) plane of the FePt alloy having the L1₀ structure, thereby improving the (001) orientation of the FePt alloy film.

Because the sputtering target including MgO used by the sputtering method is normally an insulator, it is preferable to employ the RF sputtering method as the sputtering method. On the other hand, if the sputtering target is electrically conductive, a DC sputtering method or a DC magnetron sputtering method may be employed as the sputtering method.

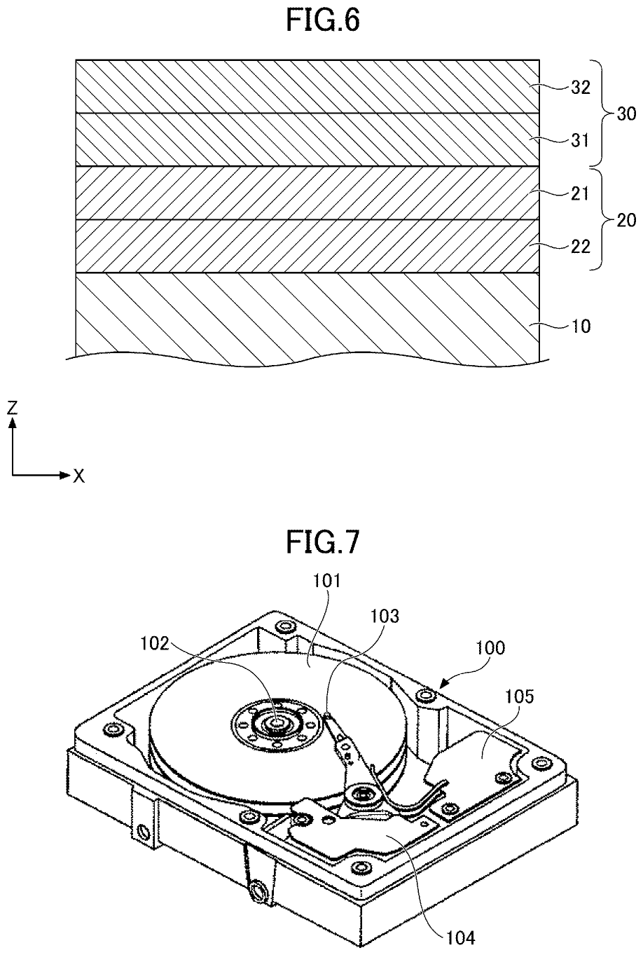

Next, the magnetic layer 30 is formed on the surface of the MgO underlayer 21, as illustrated in FIG. 6, in a magnetic layer forming step.

In the magnetic layer forming step, the first magnetic layer 31 is formed on the surface of the underlayer 21, in a first magnetic layer forming step.

The first magnetic layer 31 can be formed by a sputtering method using a target which includes a material forming the first magnetic layer 31.

The target including the material forming the first magnetic layer 31 is preferably a target including an alloy having the L1₀ structure. The alloy having the L1₀ structure may be an alloy including Fe or Co, and Pt, or the like. The alloy having the L1₀ structure may be a FePt alloy, a CoPt alloy, or the like, for example.

The DC magnetron sputtering method, and the RF sputtering method can be used as the sputtering method for the film deposition.

When forming the first magnetic layer 31, a radio frequency (RF) bias, a direct current (DC) bias, a pulse DC, a pulse DC bias, or the like may be used, as appropriate.

An O₂ gas, a H₂O gas, an N₂ gas or the like may be used as a reactive gas.

A sputtering gas pressure is appropriately adjusted to optimize the properties of each layer, may normally fall within a range of approximately 0.1 Pa to approximately 30 Pa.

Thereafter, the second magnetic layer 32 is formed on the surface of the first magnetic layer 31, in a second magnetic layer forming step.

The method for forming the second magnetic layer 32 may employ the sputtering method using the target including a material forming the second magnetic layer 32, similar to the method for forming the first magnetic layer 31.

A target, similar to the target including the material forming the first magnetic layer 31, can be used as the target including the material forming the second magnetic layer 32.

The sputtering conditions of the second magnetic layer 32 may be similar to the sputtering conditions of the first magnetic layer 31.

Next, the protective layer 40 is formed on the surface of the magnetic layer 30, as illustrated in FIG. 1, in a protective layer forming step.

A method for depositing the protective layer 40 is not particularly limited, and may include a radio frequency-chemical vapor deposition (RF-CVD) method which deposits a film by decomposing a source gas including hydrocarbon using high-frequency plasma, an ion beam deposition (IBD) method which deposits a film by ionizing the source gas using electrons emitted from a filament, a filtered cathodic vacuum arc (FCVA) method which deposits a film by using a solid carbon target without using a source gas, or the like.

Further, the lubricant layer 50 may be formed on the surface of the protective layer 40 using a general coating method or the like, in a lubricant layer forming step.

The method for manufacturing the magnetic recording medium according to the present embodiment includes the steps of forming the MgO underlayer, and forming the magnetic layer. In the MgO underlayer forming step, the MgO target including MgO is heated to a temperature of 600° C. or higher, to form the MgO underlayer 21. Hence, it is possible to reduce the generation of sputtering dust inside the chamber of the sputtering apparatus caused by the MgO target when forming the MgO underlayer 21. Accordingly, the MgO underlayer 21 can be deposited in a state having a high crystal orientation and reduced number of defects. As a result, when the MgO included in the MgO underlayer 21 is measured by the XPS, the peak in the O1s spectrum is detected within the range of 531 eV to 533 eV. From the measurement result of the XPS, it can be observed that the MgO underlayer 21 is (100) oriented with a high crystal orientation. When the FePt alloy is used as the magnetic layer 30, the (001) plane is used as the crystal orientation plane of the magnetic layer 30. For this reason, the crystal orientation of the magnetic layer 30 formed on the surface the MgO underlayer 21 can be improved, by improving the crystal orientation of the MgO underlayer 21. Further, by improving the crystal orientation, it is possible to reduce the defects generated in the magnetic layer 30. Hence, according to the method for manufacturing the magnetic recording medium according to the present embodiment, it is possible to manufacture the magnetic recording medium 1 including the magnetic layer 30 with a high crystal orientation and reduced defects.

In other words, when the first magnetic layer 31 or the second magnetic layer 32 included in the magnetic layer 30 includes the FePt alloy, the (001) plane is used as the crystal orientation plane of the magnetic layer 30. In addition, the MgO included in the MgO underlayer 21 is (100) oriented. Because the (100) plane of the MgO included in the MgO underlayer 21 is highly lattice-matched to the (001) plane of the FePt alloy having the L1₀ structure and included in the magnetic layer 30, the magnetic layer 30 including the FePt alloy is easily (001) oriented by depositing the magnetic layer 30 including the FePt alloy on the MgO underlayer 21. For this reason, by improving the crystal orientation and reducing the defects of the MgO underlayer 21, it is possible to improve the crystal orientation and reduce the defects of the magnetic layer 30 formed on the surface of the MgO underlayer 21.

The method for manufacturing the magnetic recording medium according to the present embodiment can form the MgO underlayer 21 with improved crystal orientation and reduced generation of defects, without having to manufacture the target including the high density of MgO as the sputtering target, in the MgO underlayer forming step. Hence, according to the method for manufacturing the magnetic recording medium according to the present embodiment, it is possible to form the MgO underlayer 21 having the high crystal orientation and the reduced defects, using an existing target including MgO.

In the method for manufacturing the magnetic recording medium according to the present embodiment, the target including MgO can be heated to a temperature of 800° C. or higher, to form the MgO underlayer 21 in the MgO underlayer forming step. Accordingly, it is possible to more positively improve the crystal orientation of the MgO underlayer 21, and more positively reduce the defects. As a result, it is possible to also improve the crystal orientation of the magnetic layer 30 formed on the surface of the MgO underlayer 21, and to reduce the defects in the magnetic layer 30. Thus, according to the method for manufacturing the magnetic recording medium according to the present embodiment, the magnetic recording medium 1 can have the magnetic layer 30 with a high crystal orientation and reduced defects.

In the method for manufacturing the magnetic recording medium according to the present embodiment, the magnetic layer 30 can include at least one of the FePt alloy and the CoPt alloy having the L1₀ structure. Both the FePt alloy and the CoPt alloy are high-Ku materials having the Ku on the order of 1×10⁶ J/m³. For this reason, by using at least one of the FePt alloy and the CoPt alloy as the material forming the magnetic layer 30, the size of the magnetic grains forming the magnetic layer 30 can be reduced to the grain diameter of 6 nm or less, for example, while maintaining the thermal stability. Hence, when the thermal assist recording method is used as the recording method, the magnetic layer 30 can have a coercivity of several tens of kOe at room temperature, and the information can be easily be magnetically recorded in the magnetic layer 30 by a recording magnetic field of the magnetic head.

In addition, the magnetic layer 30 including at least one of the FePt alloy and the CoPt alloy can use the (001) plane as the crystal orientation plane. Because the MgO underlayer 21 is (100) oriented, the (100) plane of MgO or CoPt is highly lattice-matched to the (001) plane of the FePt alloy, thereby easily improving the crystal orientation of the magnetic layer 30. Thus, according to the method for manufacturing the magnetic recording medium according to the present embodiment, the magnetic recording medium 1 can have the magnetic layer 30 with the high crystal orientation and reduced defects.

[Magnetic Storage Apparatus]

A magnetic storage apparatus using the magnetic recording medium according to the present embodiment will be described. A configuration of the magnetic storage apparatus according to the present embodiment is not particularly limited, as long as the magnetic recording medium according to the present embodiment is provided. Hereinafter, an example will be described in which the information is magnetically recorded on the magnetic recording medium by the magnetic storage apparatus employing the thermal assist recording method.

The magnetic storage apparatus according to the present embodiment may include a medium driving device for rotating the magnetic recording medium according to the present embodiment, a magnetic head having a near-field light generating element on a tip end thereof, a head driving device for moving the magnetic head, and a signal processor for processing signals recorded on and reproduced from the magnetic recording medium, for example.

In addition, the magnetic head includes a laser light generator for heating the magnetic recording medium, and a waveguide for guiding laser light generated from the laser light generator to the near-field light generating element, for example.

FIG. 7 is a perspective view illustrating an example of the magnetic storage apparatus using the magnetic recording medium according to the present embodiment. As illustrated in FIG. 7, a magnetic storage apparatus 100 may include a magnetic recording medium 101, a medium driving device 102 for rotating the magnetic recording medium 101, a magnetic head 103 having a near-field light generating element on a tip end thereof, a head driving device 104 for moving the magnetic head 103, and a signal processor 105. The magnetic recording medium 1 according to the embodiment described above may be used as the magnetic recording medium 101.

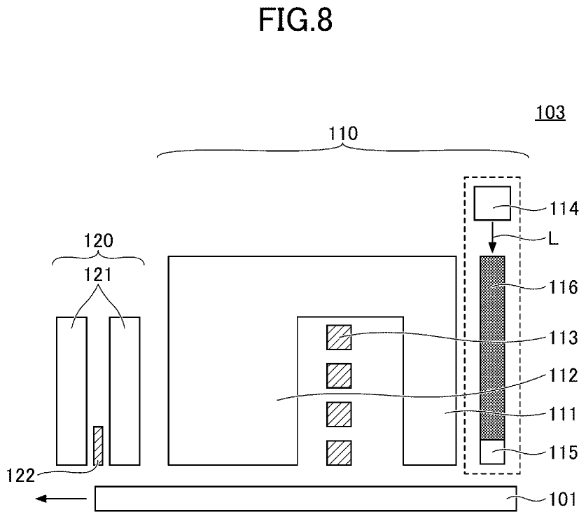

FIG. 8 is a schematic diagram illustrating an example of the magnetic head 103. As illustrated in FIG. 8, the magnetic head 103 includes a recording head 110, and a reproducing head 120.

The recording head 110 has a main pole 111, an auxiliary pole 112, a coil 113 for generating a magnetic field, a laser diode (LD) 114 as the laser light generator, and a waveguide 116 for transmitting laser light L generated from the LD 114 to the near-field light generating element 115.

The reproducing head 120 includes a pair of shields 121, and a reproducing element 122 sandwiched between the pair of shields 121.

As illustrated in FIG. 3, in the magnetic storage apparatus 100, a center portion of the magnetic recording medium 101 is attached to a rotation shaft of a spindle motor, and the information is recorded on or reproduced from the magnetic recording medium 101, which is driven and rotated by the spindle motor, while the magnetic head 103 moves over the surface of the magnetic recording medium 101 in a floating state.

The magnetic storage apparatus 100 according to the present embodiment can increase the recording density by using, as the magnetic recording medium 101, the magnetic recording medium 1 according to the present embodiment which can achieve high-density recording.

### Exemplary Implementations

Hereinafter, the embodiment will be specifically described by referring to exemplary implementations and comparative examples, however, the present disclosure is not limited to the embodiment and exemplary implementations.

### Exemplary Implementation EI1

[Manufacturing Magnetic Recording Medium]

The magnetic recording medium was manufactured by the following method.

A 50 at % Cr-50 at % Ti alloy film (third underlayer) having a thickness of 50 nm, and a 75 at % Co-20 at % Ta-5 at % B alloy film (soft magnetic underlayer) having a thickness of 25 nm were successively deposited on a heat-resistant glass substrate in this order. Then, after heating the substrate to 250° C., a Cr film (second underlayer) having a thickness of 10 nm was deposited. A DC magnetron sputtering apparatus (C-3040 manufactured by Canon Anelva Corporation) was used to deposit the third underlayer, the soft magnetic underlayer, and the second underlayer.

Next, an RF sputtering apparatus was used to form a MgO underlayer, as the first underlayer. More particularly, a MgO target having a relative density of 85% and a diameter of 120 mm was used, and the MgO film was deposited to a thickness of 2 nm by setting the target temperature to 1000° C., the input power to 1 kW, the sputtering gas to Ar, the sputtering gas pressure to 3 Pa, and the discharge to 12 seconds.

Next, after heating the substrate to 520° C., a 60 mol % (52 at % Fe-48 at % Pt)-40 mol % C film (first magnetic layer) having a thickness of 3 nm, and a 82 mol % (52 at % Fe-48 at % Pt)-18 mol % SiO₂ film (second magnetic layer) having a thickness of 5 nm were deposited in this order. The DC magnetron sputtering apparatus (C-3040 manufactured by Canon Anelva Corporation) was used to deposit the first magnetic layer and the second magnetic layer.

Next, a carbon film having a thickness of 3 nm was deposited as the protective layer using an ion beam method, and a perfluoropolyether film was then formed as the lubricant layer by the coating method, to obtain the magnetic recording medium.

((001) Orientation of Magnetic Layer)

An X-ray diffraction spectrum of the substrate after depositing the second magnetic layer was measured using an X-ray diffractometer (manufactured by Koninklijke Philips N.V.), to determine a full width at half maximum (FWHM) of a (200) peak of the FePt alloy.

The (001) orientation of the second magnetic layer was evaluated using the FWHM of the (200) peak of the FePt alloy included in the second magnetic layer and having the L1₀ structure. In this case, a (001) peak of the FePt alloy does not have a sufficiently large scattering angle 2θ. For this reason, even if the low angle side is extended to a measurement limit when measuring a rocking curve, an intensity of the (001) peak of the FePt alloy is not stable with respect to a case where no peak is present, and it is difficult to analyze the FWHM. For this reason from a measurement viewpoint, it is difficult to evaluate the (001) orientation of the magnetic layer using the FWHM of the (001) peak of the FePt alloy. On the other hand, the (200) peak of the FePt alloy appears when the FePt alloy is (001) oriented, and is suitable for evaluating the (001) orientation of the magnetic layer because the scattering angle 2θ is sufficiently large.

Table 1 illustrates the evaluation results of the FWHM of the (200) peak of the FePt alloy. In addition, the yield when 1000 magnetic recording media were manufactured under the same conditions as those described above was evaluated using an error tester. Evaluation results of the yield are also illustrated in Table 1.

### Exemplary Implementations EI2 and EI3, and Comparative Example Cmp1

In exemplary implementations EI2 and EI3 and a comparative example Cmp1, the heating temperature of the MgO target when depositing the MgO underlayer was changed from that of the exemplary implementation EI1, as illustrated in Table 1. Otherwise, the magnetic recording media were manufactured in the same manner as in the exemplary implementation EI1. Table 1 illustrates the evaluation results of the FWHM of the (200) peak of the FePt alloy, and the yield when 1000 magnetic recording media were manufactured under the same conditions as those described above was evaluated using the error tester, for the exemplary implementations EI2 and EI3, and the comparative example Cmp1.

TABLE 1

| | Heating | | |
|---|---|---|---|
| | temperature | | |
| | [° C.] of | FWHM | |
| | MgO target | value [°] | |
| | when forming | of (200) | |
| | MgO | peak of | |
| | underlayer | FePt alloy | Yield [%] |
| EI1 | 1000 | 7.17 | 99.5 |
| EI2 | 800 | 7.38 | 99.1 |
| EI3 | 600 | 7.56 | 98.7 |
| Cmp1 | Room | 7.77 | 98.1 |
| | Temperature | | |

From Table 1, the yield when 1000 magnetic recording media were manufactured was 98.7% or higher for the exemplary implementations EI1, EI2, and EI3. On the other hand, the yield when 1000 magnetic recording media were manufactured was 98.1% for the comparative example Cmp1.

In the exemplary implementations EI1, EI2, and EI3, unlike comparative example Cmp1, it was confirmed that the orientation of the second magnetic layer and the yield can be improved by setting the MgO target temperature to 600° C. or higher when forming the MgO underlayer, and depositing the MgO underlayer when manufacturing the magnetic recording medium. Hence, according to the method for manufacturing the magnetic recording medium according to the present embodiment, the magnetic recording media can be manufactured with a high efficiency.

Although the embodiments and exemplary implementations are described as above, the embodiments and exemplary implementations are presented as examples, and the present disclosure is not limited to the embodiments and exemplary implementations. The embodiments may be implemented in various other forms, and various combinations, omissions, substitutions, modifications, variations, or the like may be made without departing from the spirit and scope of the present disclosure.

According to the embodiments and exemplary implementations described above, it is possible to provide a method for manufacturing a magnetic recording medium which can have a magnetic layer with a high crystal orientation and reduced defects.

Although the exemplary implementations are numbered with, for example, “EI1,” “EI2,” “EI3,” or the like, the ordinal numbers do not imply priorities of the exemplary implementations.

Further, the present invention is not limited to these embodiments and exemplary implementations, but various combinations, omissions, substitutions, modifications, and variations may be made without departing from the scope of the present disclosure.

What is claimed is:

1. A magnetic recording medium comprising:
a magnesium oxide underlayer including magnesium oxide; and
a magnetic layer including an alloy having a L1₀ structure and includes Fe or Co and Pt,
wherein the magnesium oxide has a peak in an O1s spectrum detected in a range of 531 eV to 533 eV when measured by an X-ray photoelectron spectroscopy.

2. The magnetic recording medium as claimed in claim 1, wherein the magnetic layer includes at least one of a FePt alloy and a CoPt alloy having the L1₀ structure, respectively.

3. A magnetic storage apparatus comprising:
a magnetic recording medium according to claim 1; and
a head configured to record information on and reproduce information from the magnetic recording medium.

4. A method for manufacturing a magnetic recording medium, comprising:
forming a magnesium oxide underlayer on a surface of a substrate by a sputtering method using a target which includes magnesium oxide; and
forming a magnetic layer on a surface of the magnesium oxide underlayer,
wherein the target including the magnesium oxide is heated to a temperature of 600° C. or higher when forming the magnesium oxide underlayer.

5. The method for manufacturing the magnetic recording medium as claimed in claim 4, wherein the target including the magnesium oxide is heated to a temperature of 800° C. or higher when forming the magnesium oxide underlayer.

6. The method for manufacturing the magnetic recording medium as claimed in claim 4, wherein the magnetic layer includes at least one of a FePt alloy and a CoPt alloy having a L1₀ structure, respectively.
